(19) United States
(12) Patent Application Publication
(10) Pub. No.: US 2009/0136769 A1
(43) Pub. Date: May 28, 2009

(54) Alloy, Protective Layer for Protecting a Component Against Corrosion and Oxidation at High Temperatures and Component

(76) Inventor: Werner Stamm, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/084,080

(22) PCT Filed: Oct. 6, 2006
(86) PCT No.: PCT/EP2006/067123

§ 371 Date: Apr. 24, 2008

(30) Foreign Application Priority Data
Oct. 25, 2005 (EP) 05023321.2

(51) Int. Cl. B32B 15/04; C22C 19/05

(52) U.S. Cl. 428/457; 420/443

(57) ABSTRACT

Disclosed is a protective layer having the composition 1.5% to 2.5% rhenium, 11% to 13% cobalt, 20% to 22% chrome, 10.5% to 11.5% aluminum, 0.3% to 0.5% yttrium and or at least one equivalent metal selected from the group comprising scandium and the rare earths and the remainder consists of nickel. Existing protective layers which have a high Al and/or Cr content and which are additionally reinforced by Re-forming brittle phases that, during use, additionally embrittle under the influence of carbon. The present invention hardly exhibits a brittleness by Cr/Re depositions.

### CROSS REFERENCE TO RELATED APPLICATIONS

This application is the US National Stage of International Application No. PCT/EP2006/067123, filed Oct. 6, 2006 and claims the benefit thereof. The International Application claims the benefits of European application No. 05023321.2 filed Oct. 25, 2005, both of the applications are incorporated by reference herein in their entirety.

### FIELD OF INVENTION

The invention relates to an alloy as claimed in the claims, to a protective layer for protecting a component against corrosion and oxidation at high temperatures as claimed in the claims and to a component according to the claims.

The invention relates in particular to a protective layer for a component which consists of a nickel- or cobalt-based superalloy.

### BACKGROUND OF THE INVENTION

Large numbers of protective layers for metal components, which are intended to increase their corrosion resistance and/or oxidation resistance, are known in the prior art. Most of these protective layers are known by the generic name MCrAlY, where M stands for at least one of the elements in the group comprising iron, cobalt and/or nickel and the other essential constituents are chromium, aluminum and yttrium.

Furthermore, numerous special compositions for protective layers of the above type are known from EP 0 194 392 B1 with admixtures of further elements for various application purposes. Besides many other selectively addable elements, the element rhenium is also mentioned with admixtures of up to a 10% proportion by weight. Owing to loosely specified further ranges for possible admixtures, however, none of the disclosed protective layers is qualified for special conditions such as occur, for example, on rotor blades and guide vanes of gas turbines with high intake temperatures, which need to be operated over prolonged periods of time.

Protective layers, which contain rhenium, are also known from U.S. Pat. No. 5,154,885 and EP0652 299 B1.

EP 1 306 454 B1 likewise discloses a protective layer consisting of nickel, cobalt, chromium, aluminum, rhenium and yttrium. Data about the levels of nickel and cobalt are not provided.

U.S. Pat. No. 6,346,134 B1 discloses an MCrAlY layer having a chromium content of from 20 wt % to 35 wt %, an aluminum content of from 5 wt % to 15 wt %, additions of hafnium, rhenium, lanthanum or tantalum and a high yttrium content of from 4 wt % to 6 wt %.

U.S. Pat. No. 6,280,857 B1 discloses a protective layer which discloses the elements cobalt, chromium and aluminum based on nickel, the optional addition of rhenium and mandatory additions of yttrium and silicon.

The endeavor to increase the intake temperatures both in static gas turbines and in aircraft engines is of great importance in the specialist field of gas turbines, since the intake temperatures are important determining quantities for the thermodynamic efficiencies achievable with gas turbines. Intake temperatures significantly higher than 1000° C. are possible when using specially developed alloys as base materials for components to be heavily loaded thermally, such as guide vanes and rotor blades. To date, the prior art permits intake temperatures of 950° C. or more for static gas turbines and 1100° C. or more in gas turbines of aircraft engines.

While the physical loading capacity of the base materials so far developed for the components to be heavily loaded is substantially unproblematic in respect of possible further increases in the intake temperatures, it is necessary to resort to protective layers in order to achieve sufficient resistance against oxidation and corrosion. Besides the sufficient chemical stability of a protective layer under the aggressions which are to be expected from exhaust gases at temperatures of the order of 1000° C., a protective layer must also have sufficiently good mechanical properties, not least in respect of the mechanical interaction between the protective layer and the base material. In particular, the protective layer must be ductile enough to be able to accommodate possible deformations of the base material and not crack, since points of attack would thereby be provided for oxidation and corrosion. The problem then typically arises that increasing the levels of elements such as aluminum and chromium, which can improve the resistance of a protective layer against oxidation and corrosion, leads to a deterioration of the ductility of the protective layer so that mechanical failure is possible, in particular the formation of cracks, under a mechanical load conventionally occurring in a gas turbine. Examples of the reduction of the protective layer's ductility by the elements chromium and aluminum are known in the prior art.

A superalloy, which likewise contains rhenium, for a substrate is known from WO 01/09403 A1. It describes that the intermetallic phases formed by rhenium reduce the longterm stability of the superalloy.

### SUMMARY OF INVENTION

It is therefore an object of the invention to provide an alloy and a protective layer, which has good high-temperature resistance to corrosion and oxidation, has good longterm stability and which is furthermore adapted particularly well to a mechanical load which is to be expected particularly in a gas turbine at a high temperature.

The object is achieved by an alloy and a protective layer as claimed in the claims.

It is another object of the invention to provide a component which has increased protection against corrosion and oxidation.

The object is likewise achieved by a component, in particular a component of a gas turbine or steam turbine, which comprises a protective layer of the type described above for protection against corrosion and oxidation at high temperatures.

Further advantageous measures are listed in the dependent claims.

The measures listed in the dependent claims may be combined arbitrarily with one another in an advantageous way.

The invention is based inter alia on the discovery that the protective layer exhibits brittle chromium-rhenium precipitates in the layer and in the transition region between the protective layer and the base material. These brittle phases, which are formed to a greater extent with time and temperature during use, lead during operation to very pronounced longitudinal cracks in the layer as well as in the layer-base material interface, with subsequent shedding of the layer. The brittleness of the Cr—Re precipitates is further increased by the interaction with carbon, which can diffuse into the layer from the base material or diffuses into the layer through the surface during a heat treatment in the oven. The engine is made even more susceptible to cracking by oxidation of the chromium-rhenium phases.

Protective layers which contain rhenium are also known from U.S. Pat. No. 5,154,885 and EP 0 652 299 B1. The entire disclosure about the interaction of the rhenium as revealed by these documents is fully incorporated into the present disclosure.

The effect of cobalt, which determines the thermal and mechanical properties, is also important in this case.

### BRIEF DESCRIPTION OF THE DRAWINGS

The invention will be explained in more detail below.

FIG. 1 shows a layer system having a protective layer,

FIG. 2 shows experimental results of cyclic loading tests,

FIG. 3 shows a table of superalloys,

FIG. 4 shows a gas turbine,

FIG. 5 shows a perspective view of a combustion chamber and

FIG. 6 shows a perspective view of a turbine blade.

### DETAILED DESCRIPTION OF INVENTION

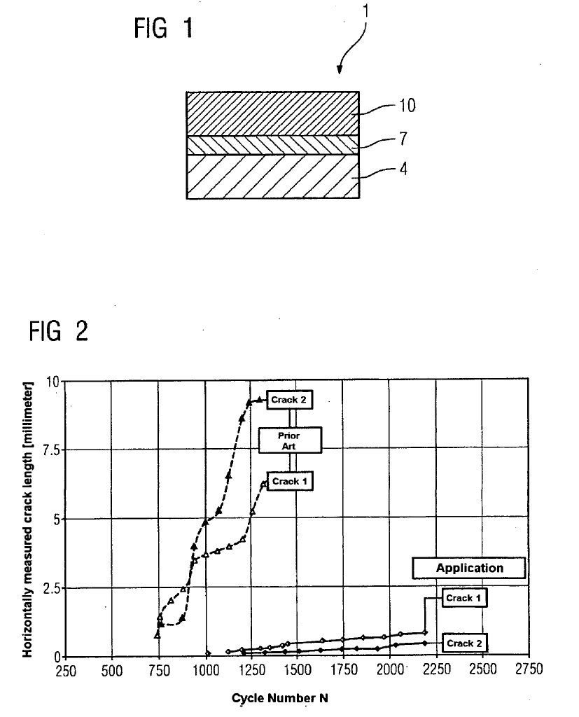

According to the invention a protective layer 7 (FIG. 1) for protecting a component 1, 120, 130, 138, 155 (FIGS. 1, 4, 5, 6) against corrosion and oxidation at a high temperature comprises the following elements (data in wt %):

11% to 13% cobalt,

20% to 22% chromium,

10.5% to 11.5% aluminum,

1.5% to 2.5% rhenium,

0.3% to 0.5% yttrium and/or at least one equivalent metal from the group comprising scandium and the rare earth elements, and the remainder nickel.

The alloy may also comprise further elements. Preferably, however, the alloy consists of nickel, cobalt, chromium, aluminum, yttrium and rhenium.

The advantageous effect of the element rhenium is thereby utilized while preventing the brittle phase formation.

It is to be noted that the levels of the individual elements are specially adapted with a view to their effects, which are to be considered in combination with the element rhenium. If the levels are set so that no chromium-rhenium precipitates are formed, no brittle phases are advantageously created during use of the protective layer so that the longterm behavior is improved and extended.

This is achieved not only by a low chromium content but also, taking into account the effect of aluminum on the phase formation, by accurately setting the aluminum content.

The low choice of from 11% to 13% cobalt surprisingly improves the thermal and mechanical properties of the protective layer 7 significantly and superproportionally.

This narrowly selected range of cobalt suppresses particularly well the creation and further formation of the γ′ phase of the alloy, which normally leads to a peak in the thermal expansion coefficient of the alloy.

During strong heating of the component with the protective layer 7 (startup of the turbine) or other temperature fluctuations, this peak would otherwise cause high mechanical stresses (thermal mismatch) between a protective layer 7 and a substrate 4 (FIG. 1) of the component 1, 120, 130, 138, 155.

This is at least drastically reduced by the cobalt content selected according to the invention. In conjunction with the reduction of the brittle phases, which have a detrimental effect especially under high mechanical properties, the mechanical properties are improved by the reduction of the mechanical stresses through the selected cobalt content.

Together with good corrosion resistance, the protective layer has particularly good resistance against oxidation and is also distinguished by particularly good ductility properties, so that it is particularly qualified for use in a gas turbine with a further increase in the intake temperature. During operation, embrittlement scarcely takes place since the layer comprises hardly any chromium-rhenium precipitates which are embrittled in the course of use. The superalloy comprises no chromium-rhenium precipitates, or at most 6 vol % thereof.

It is particularly favorable to set the level of rhenium at 2%, the chromium content at 21%, the aluminum content at 11%, the cobalt content at 12% and the yttrium content at 0.4%. Certain variations are encountered owing to industrial mass production, so that yttrium contents of from 0.2% to 0.3% or from 0.4% to 0.6% are also used and likewise exhibit good properties.

The trace elements in the powder to be sprayed and therefore in the protective layer 7, which form precipitates and therefore represent embrittlements, play a likewise important role.

The powders are for example applied by plasma spraying (APS, LPPS, VPS, . . . ). Other methods may likewise be envisaged (PVD, CVD, cold gas spraying, . . . ).

The sum of the trace elements in the protective layer 7 is in particular <0.5% in total and is advantageously distributed as follows between the individual elements: carbon<250 ppm, oxygen<400 ppm, nitrogen<100 ppm and hydrogen<50 ppm.

In the case of this component 1, the protective layer 7 is advantageously applied onto a substrate 4 made of a nickel-based or cobalt-based superalloy.

The compositions of the superalloys listed in FIG. 3 are suitable as the substrate 4, in particular the alloys which form a DS or SX structure.

The thickness of the protective layer 7 on the component 1 is preferably set to a value of between 100 μm and 300 μm.

The protective layer 7 is particularly suitable for protecting a component against corrosion and oxidation while the component is being exposed to an exhaust gas at a material temperature of about 950° C., or even about 1100° C. in aircraft turbines.

The protective layer 7 according to the invention is therefore particularly qualified for protecting a component 1, 120, 130, 138, 155 of a gas turbine 100, in particular a guide vane 130, rotor blade 120 or other components, which are exposed to hot gas before or in the turbine of the gas turbine 100.

The protective layer 7 may be used as an overlay (the protective layer is the outer layer) or as a bondcoat (the protective layer is an interlayer and adhesion promoter layer).

Further layers, in particular ceramic thermal barrier layers 10 (FIG. 1) may be applied onto this protective layer 7.

FIG. 1 shows a layer system 1 as a component.

The layer system 1 consists of a substrate 4.

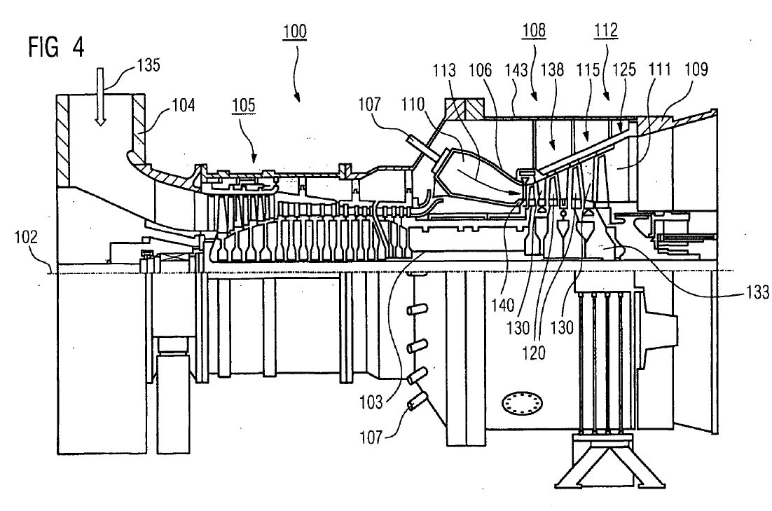

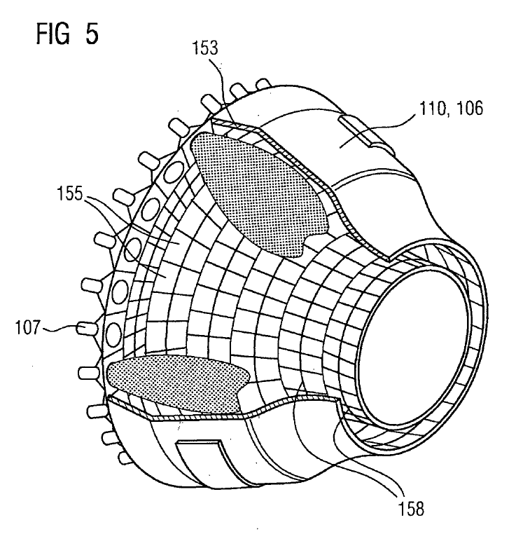

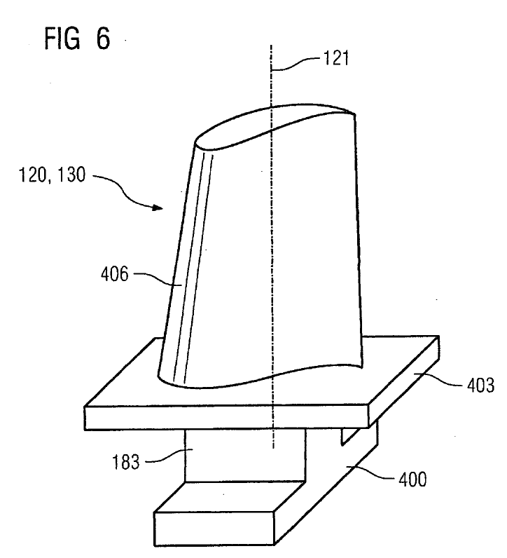

The substrate 4 may be metallic and/or ceramic. Particularly in the case of turbine components, for example turbine rotor blades 120 (FIG. 6) or guide vanes 130 (FIGS. 4, 6), combustion chamber linings 155 (FIG. 5) and other housing parts 138 of a steam or gas turbine 100 (FIG. 4), the substrate 4 consists of a nickel- or cobalt-based superalloy.

The protective layer 7 according to the invention is placed on the substrate 4.

This protective layer 7 is preferably applied by LPPS (low pressure plasma spraying) or by cold gas spraying.

The protective layer 7 may be applied onto newly produced components 1 and refurbished components 1.

Refurbishment means that components 1 are optionally separated from layers (thermal barrier layer) after their use and corrosion and oxidation products are removed, for example by an acid treatment (acid stripping). It may sometimes also be necessary to repair cracks. Such a component may subsequently be recoated, since the substrate 4 is very expensive.

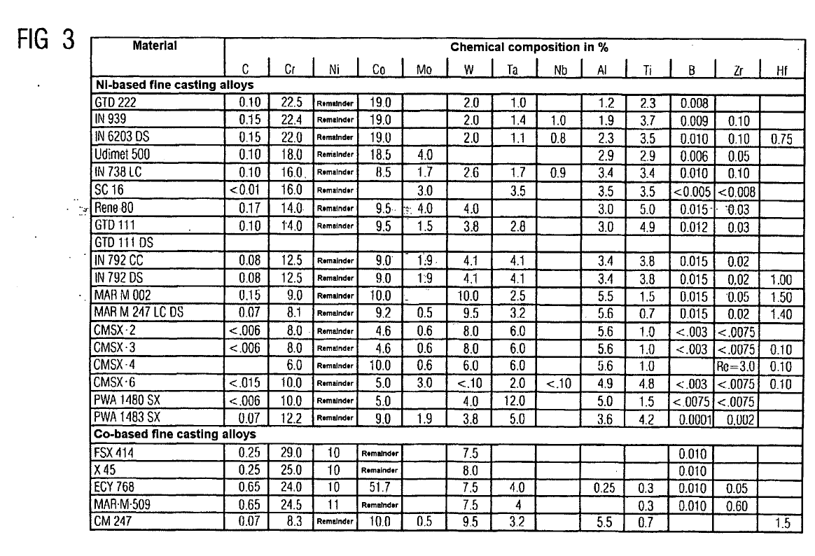

FIG. 2 shows experimental results of loading specimens which were subjected to cyclic loads, i.e. experimental results for a specimen (application) having a composition according to the present application (claim 2) and experimental results for a layer according to the prior art (prior art) which comprises a composition according to U.S. Pat. Nos. 5,154,885, 5,273,712 or U.S. Pat. No. 5,268,238.

The layers were applied onto a substrate with the designation PWA 1484 (Pratt & Whitney alloy).

The specimens were exposed to a particular cyclic mechanical load (vibration loading) and cyclic thermal loading (TMF tests).

The tests were carried out under strain control with 0.50% strain.

The horizontally measured crack length is plotted in FIG. 2 against the number of cycles.

It can be seen clearly that the layer according to the prior art already has cracks after 750 cycles, and they grow very much more rapidly than in a layer according to the application.

In the layer according to the application cracks only occur below 1000 cycles, and furthermore they are still very much smaller than those of the layer according to the prior art. The crack growth over the number of cycles is also much less.

This demonstrates the superiority of the protective layer 7 according to the invention.

FIG. 4 shows by way of example a gas turbine 100 in a longitudinal partial section.

The gas turbine 100 internally comprises a rotor 103, or turbine rotor, mounted so that it can rotate about a rotation axis 102.

Successively along the rotor 103, there are an intake manifold 104, a compressor 105, an e.g. toroidal combustion chamber 110, in particular a ring combustion chamber 106, having a plurality of burners 107 arranged coaxially, a turbine 108 and the exhaust manifold 109.

The ring combustion chamber 106 communicates with an e.g. annular hot gas channel 111. There, for example four successively connected turbine stages 112 form the turbine 108.

Each turbine stage 112 is formed by two blade rings. As seen in the flow direction of a working medium 113, a row 125 formed by rotor blades 120 follows in the hot gas channel 111 of a guide vane row 115.

The guide vanes 130 are fastened on an inner housing 138 of a stator 143, while the rotor blades 120 of a row 125 are fastened on the rotor 103 for example by means of a turbine disk 133. Coupled to the rotor 103, there is a generator or a work engine (not shown).

During operation of the gas turbine 100, air 135 is taken in by the compressor 105 through the intake manifold 104 and compressed. The compressed air provided at the turbine-side end of the compressor 105 is delivered to the burners 107 and mixed there with a fuel. The mixture is then burnt to form the working medium 113 in the combustion chamber 110.

From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

During operation of the gas turbine 100, the components exposed to the hot working medium 113 experience thermal loads. Apart from the heat shield blocks lining the ring combustion chamber 106, the guide vanes 130 and rotor blades 120 of the first turbine stage 112, as seen in the flow direction of the working medium 113, are thermally loaded most greatly.

In order to withstand the temperatures prevailing there, they are cooled by means of a coolant.

The substrates may likewise comprise a directional structure, i.e. they are monocrystalline (SX structure) or comprise only longitudinally directed grains (DS).

Iron-, nickel- or cobalt-based superalloys are used as material.

For example, superalloys such as those known from EP 1 204 776, EP 1 306 454, EP 1 319 729, WO 99/67435 or WO 00/44949 are used. These documents are part of the disclosure in respect of the composition of the superalloys and their advantages.

The blades and vanes 120, 130 comprise protective layers 7 according to the invention against corrosion and corrosion and/or a thermal barrier layer. The thermal barrier layer consists for example of ZrO₂, Y₂O₃—ZrO₂, i.e. it is non-stabilized or partially or fully stabilized by yttrium oxide and/or calcium oxide and/or magnesium oxide.

Columnar grains are generated in the thermal barrier layer by suitable coating methods, for example electron beam deposition (EB-PVD).

The guide vanes 130 comprise a guide vane root (not shown here) facing the inner housing 138 of the turbine 108, and a guide vane head lying opposite the guide vane root. The guide vane head faces the rotor 103 and is fastened on a fastening ring 140 of the stator 143.

FIG. 5 shows a combustion chamber 110 of a gas turbine, which may comprise a layer system 1.

The combustion chamber 110 is designed for example as a so-called ring combustion chamber, in which a multiplicity of burners 102 arranged in the circumferential direction around the turbine shaft 103 open into a common combustion chamber space. To this end, the combustion chamber 110 in its entirety is designed as an annular structure which is positioned around the turbine shaft 103.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M. Each heat shield element 155 is equipped with a particularly heat-resistant protective layer on the working medium side, or is made of refractory material and comprises the protective layer 7 according to FIG. 1.

Owing to the high temperatures inside the combustion chamber 110, a cooling system is also provided for the heat shield elements 155 or their holding elements.

The materials of the combustion chamber wall and its coatings may be similar to the turbine blades and vanes 120, 130.

The combustion chamber 110 is in particular designed in order to detect losses of the heat shield elements 155. To this end, a number of temperature sensors 158 are positioned between the combustion chamber wall 153 and the heat shield elements 155.

FIG. 6 shows in perspective view a blade 120, 130 which comprises a layer system 1 having the protective layer 7 according to the invention.

The blades 120, 130 extend along a longitudinal axis 121.

In succession along the longitudinal axis 121, the blades 120, 130 comprise a fastening region 400, a blade platform 403 adjacent thereto and a blade surface region 406. In particular, the protective layer 7 or a layer system 1 according to FIG. 1 is formed in the blade surface region 406.

A blade root 183, which is used for fastening the rotor blades 120, 130 on the shaft, is formed in the fastening region 400. The blade root 183 is designed as a hammerhead. Other designs are possible, for example as a firtree or dovetail root. In conventional blades 120, 130, for example, solid metallic materials are used in all regions 400, 403, 406 of the rotor blade 120, 130. The rotor blades 120, 130 may in this case be manufactured by a casting method, by a forging method, by a machining method or combinations thereof.

1-9. (canceled)

10. An alloy for protecting a component against corrosion and/or oxidation at high temperatures, comprising: (in wt %)
11% to 13% cobalt;
20% to 22% chromium;
10.5% to 11.5% aluminum;
1.5% to 2.5% rhenium;
0.3% to 0.5% yttrium and at least one equivalent metal from the group comprising scandium and the rare earth elements;
optionally levels of trace elements carbon, oxygen, nitrogen and hydrogen less than 0.5 wt %, wherein:
carbon content being <250 ppm,
oxygen content being <400 ppm,
nitrogen content being <100 ppm and
hydrogen content being <50 ppm; and
remainder nickel.

11. The alloy as claimed in claim 10, wherein
12% cobalt,
21% chromium,
11% aluminum,
0.4% yttrium and/or an equivalent metal from the group comprising scandium and the rare earth elements, and
2% rhenium.

12. The alloy as claimed in claim 10, consisting of nickel, cobalt, chromium, aluminum, yttrium and rhenium.

13. A protective layer for protecting a component against high temperatures, comprising: (in wt %)
11% to 13% cobalt;
20% to 22% chromium;
10.5% to 11.5% aluminum;
1.5% to 2.5% rhenium;
0.3% to 0.5% yttrium and at least one equivalent metal from the group comprising scandium and the rare earth elements;
optionally levels of trace elements carbon, oxygen, nitrogen and hydrogen less than 0.5 wt %, wherein:
carbon content being <250 ppm,
oxygen content being <400 ppm,
nitrogen content being <100 ppm and
hydrogen content being <50 ppm; and
remainder nickel.

14. The protective layer as claimed in claim 13, wherein chromium-rhenium precipitates comprise at most 6 vol %.

15. A gas turbine component, comprising:
a substrate; and
a protective layer arranged on the substrate that protects the substrate from corrosion and/or oxidation at high temperatures, wherein the protective layer comprises:
11% to 13% cobalt;
20% to 22% chromium;
10.5% to 11.5% aluminum;
1.5% to 2.5% rhenium; 0.3% to 0.5% yttrium and at least one equivalent metal from the group comprising scandium and the rare earth elements;
optionally levels of trace elements carbon, oxygen, nitrogen and hydrogen less than 0.5 wt %, wherein:
carbon content being <250 ppm,
oxygen content being <400 ppm,
nitrogen content being <100 ppm and
hydrogen content being <50 ppm; and
remainder nickel.

16. The component as claimed in claim 15, wherein a ceramic thermal barrier layer is applied on the protective layer.

17. The component as claimed in claim 16, wherein the substrate of the component is nickel-based.

18. The component as claimed in claim 16, wherein the substrate of the component is cobalt-based.
